(19) United States
(12) Patent Application Publication
(10) Pub. No.: US 2003/0209006 A1
(43) Pub. Date: Nov. 13, 2003

(54) Pulsed jet augmentation

(75) Inventors: Mory Gharib, Pasadena, CA (US); Paul S. Krueger, Pasadena, CA (US)

Correspondence Address: FISH & RICHARDSON, PC, 4350 LA JOLLA VILLAGE DRIVE, SUITE 500, SAN DIEGO, CA, 92122, US

(73) Assignee: California Institute of Technology

(21) Appl. No.: 10/353,776

(22) Filed: Jan. 27, 2003

Related U.S. Application Data
(63) Continuation of application No. 09/369,736, filed on Aug. 6, 1999, now abandoned.
(60) Provisional application No. 60/095,832, filed on Aug. 7, 1998.

(51) Int. Cl. F02K 7/02

(52) U.S. Cl. 60/204; 60/247

(57) ABSTRACT

A pump augmentation uses a nozzle output which is controlled in pulses to produce vortex rings and is controlled such that

$$F = Formation Number = \frac{m}{ρ A D} = \frac{U t}{D}$$

where

m=the total mass of fluid emitted during a single pulse of duration t,

ρ=the average density of the fluid emitted in the pulse.

A=the cross-section area of the nozzle orifice (=π/4D² for a circular nozzle),

D=the primary dimension of the nozzle orifice (=the exit diameter of the nozzle for circular nozzles),

t=pulse duration, and

U=average velocity of the fluid at the nozzle exit during one pulse (during t).

$$\begin{matrix}\begin{matrix}S {t}_{D} = \frac{f D}{{V}_{ave}} \\ and\end{matrix} \\ \frac{N}{M} S {t}_{D} = \frac{1}{F} .\end{matrix}$$

### CROSS REFERENCE TO RELATED APPLICATIONS

This application is a continuation of U.S. application serial No. 09/369,736, filed Aug. 6, 1999, which claims the benefit of U.S. provisional application serial No. 60/095,832, filed Aug. 7, 1998.

The present invention describes a technique of increasing time average thrust and/or time averaged output mass flow rate using a fluid jet of a given time averaged input mass flow rate. The system as described is useful in propulsion augmentation and/or pumping augmentation.

### BACKGROUND

Thrust can be produced by outputting fluid from a nozzle. Different ways of producing the thrust can be produce different results. One desirable result is often to increase the amount of thrust produced for a given output.

U.S. Pat. No. 4,645,140 teaches a nozzle system for augmenting thrust. Specially shaped nozzles are used to generate trailing vortices that entrain the surrounded fluid as the vortices pass through a diffuser.

Another way of attempting to enhance thrust in such a system is carried out using a pulse-jet engine. Such a device is described in U.S. Pat. Nos. 3,848,408, 4,962,641, 5,361,581, 4,767,314, 3,823,554, and 5,189,875. A pulse jet engine operates on a thermodynamic cycle. It compresses a compressible mixture, ignites it, and then expands the high pressure heated mixture through a nozzle in order to generate thrust. The pulsing of the jet occurs based on the combustion cycle. The pulsing is itself not generally used to augment thruster performance.

U.S. Pat. No. 4,926,818 describes a pulse jet combustion generator using a pulse jet of pre-ignited fuel air mixture, injected into a combustion chamber of an internal combustion engine. This generates a plume. The plume entrains the combustion reactance and enhances the combustion.

Another thrust augmenter is also described by U.S. Pat. No. 4,592,202. This system describes modification at the fluid wake at the intake of a water vessel's propeller system.

### SUMMARY

The present system describes a method of producing thrust, that emits a stream of fluid from a nozzle in pulses, in a way that produces a plurality of vortex rings. The output is done with a formation number related to total mass of fluid emitted during a single pulse, average density of the fluid in the pulse, cross-sectional area of the nozzle orifice, pulse direction duration, and average velocity of the fluid relative to the nozzle exit. A pulsing frequency of the pulse jet can also be controlled within specified limits.

More preferably, the formation number F,

$$F = Formation Number = \frac{m}{ρ A D} = \frac{U t}{D}$$

where

m=the total mass of fluid emitted during a single pulse of duration t,

ρ=the average density of the fluid emitted in the pulse.

A=the cross-sectional area of the nozzle orifice (=π/4D² for a circular nozzle),

D=the primary dimension of the nozzle orifice (=the exit diameter of the nozzle for circular nozzles),

t=pulse duration, and

U=average velocity of the fluid relative to the nozzle exit at the nozzle exit during one pulse (during t).

F is controlled to be around 4±0.5 . . . for the case where the fluid velocity is uniform, e.g. within 10-20% of uniformity across the nozzle cross section, for the duration of each pulse.

### BRIEF DESCRIPTION OF THE DRAWINGS

These and other aspects of the invention will now be described with reference to the attached drawings, in which:

FIG. 1 shows an exemplary pulsed jet system;

FIG. 2 shows a series of vortex rings formed from the operation; and

FIG. 3 shows a second embodiment with a shroud.

### DESCRIPTION OF THE PREFERRED EMBODIMENTS

The present invention describes a way of increasing the thrust from a jet in a way that is different than techniques that have been disclosed in the prior art. This special technique is referred to herein as a pulsed jet.

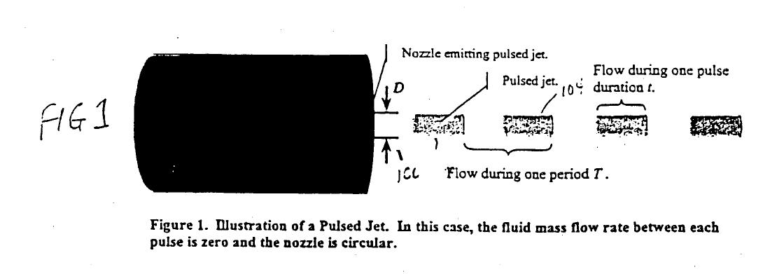

The pulsed jet is shown in FIG. 1. A stream of fluid is emitted from a nozzle 100 that forms the output of a fluid emitter 99, e.g. a jet engine or other air compressor. The nozzle 100 has of dimension D. The pulse is emitted in repeated bursts, or “pulses”. The fluid mass flow rate from the nozzle between each pulse is reduced to a level less than the peak flow rate. The fluid release does not necessarily reduce to zero, but does reduce down to a lower level.

Different kinds of nozzles can be used for this system. The dimension D represents the diameter of the nozzle orifice if a circular nozzle is used. D represents the major diameter of an elliptical nozzle. For non-circular and non-elliptical nozzles, the dimension D represents a primary dimension.

FIG. 1 shows four pulses. The pulses are periodically produced. The time between the same portion of repeated pulses of fluid, e.g., either between the peaks or the troughs in the fluid flow, is defined as the pulsing period T. The pulsing frequency is defined as the inverse of the pulsing period or 1/T. FIG. 1 illustrates the time between the pulse jets equaling one period T. The pulse duration is defined as starting when the fluid output exceeds some minimum flow rate and ending when the pulse duration goes below that minimum flow rate. The time within each period is called the pulse duration t.

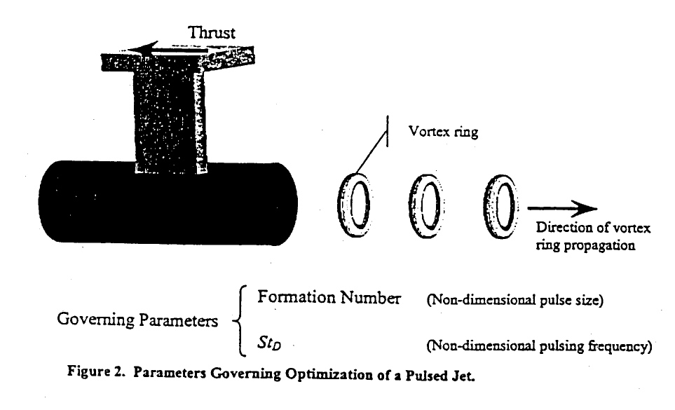

According to the present system, the pulsed jet is formed such that a vortex ring is produced at the leading edge of each pulse of fluid as shown in FIG. 2. The jet 100 produces an output that produces vortex rings propagating in the direction shown in FIG. 2.

The pulse jet formed in this way optimizes performance of the jet by controlling according to two parameters. The two parameters include the formation number F and the pulsing frequency f.

Formation number is defined as

$$F = Formation Number = \frac{m}{ρ A D} = \frac{U t}{D} \qquad ( 1 )$$

where

m=the total mass of fluid emitted during a single pulse of duration t,

ρ=the average density of the fluid emitted in the pulse.

A=the cross-section area of the nozzle orifice (=π/4D² for a circular nozzle),

D=the primary dimension of the nozzle orifice (=the exit diameter of the nozzle for circular nozzles),

t=pulse duration, and

U=average velocity of the fluid, relative to the nozzle, at the nozzle exit during one pulse (during t).

The formation number is dimensionless.

The pulsing frequency ƒ=1/T may also be expressed as a non-dimensional number as:

$$S {t}_{L} = \frac{f L}{U} = \frac{t}{T}$$

where

L=U·t

U=(defined above).

According to this system, the inventors have recognized that for the case where the flow at the nozzle exit is substantially uniform (e.g. within 10-20%) across the nozzle cross-section, the optimum formation number is around 4; more specifically 4±0.5. For cases where the flow velocity is not uniform across the nozzle cross-section, the optimum formation number decreases more as the flow becomes less uniform. The optimum number may be as low as 1.0.

When operating at the optimum formation number, the optimum St_{L} for a circular nozzle falls within the ranges

0.45<St_{L}<0.55

and

0.80<St_{L}<0.90.

The present system produces jets of fluid which form vortex rings having an optimum formation number, St_{L}, and/or pulsing frequency. The features of this system include enhanced entrainment of the surrounding fluid via the most energized vortex rings possible. This increases the time averaged mass flow rates of the fluid. In addition, this system increases the thrust for any given time-averaged input mass flow rate produced by the momentum flux of the jet via fluid entrainment, and the interaction of maximized energized vortex rings.

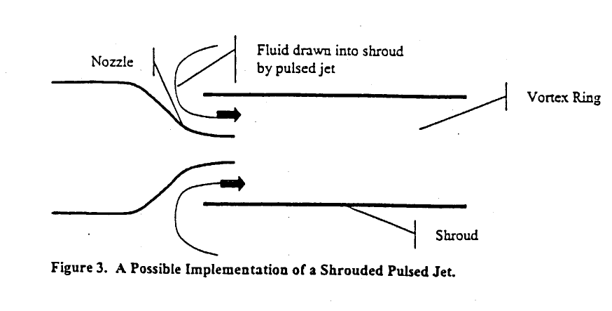

An additional modification uses a jet pumping or ejector pump that produces a pulse jet with a shroud placed around the nozzle exit as shown in FIG. 3. The shroud is mounted in a way that allows fluid surrounding and behind the nozzle to be drawn into the shroud as the vortex ring forms.

Yet another option uses micro pumping using a MEMS device.

An alternative uses this with a combuster (e.g. MEMS or macro-sized) thrust generation.

Although only a few embodiments have been described in detail above, other embodiments are contemplated by the inventor and are intended to be encompassed within the following claims. In addition, other modifications are contemplated and are also intended to be covered.

What is claimed is:

1. A device and/or method substantially as shown and described.
